(19) United States
(12) Patent Application Publication
(10) Pub. No.: US 2011/0282543 A1
(43) Pub. Date: Nov. 17, 2011

(54) SEAT BELT MONITORING SYSTEM AND METHOD OF USE

(76) Inventor: Ron Desmarais, St. Catharines (CA)

(21) Appl. No.: 12/779,402

(22) Filed: May 13, 2010

(51) Int. Cl. G06F 7/00; G08B 21/00

(52) U.S. Cl. 701/34; 701/35; 701/29; 340/540

(57) ABSTRACT

A method of monitoring the status of rear seat belts includes the following steps namely attaching wireless belt sensors including a belt portion to a seat belt and an anchor portion to a seat belt anchor; and installing a monitor into the vehicle; and turning on the belt sensors and the monitor; and sending wireless signals from the sensors to the monitor confirming the seatbelt engagement status; and displaying the seat belt status to the driver of the vehicle with a monitor display. Preferably the method includes the step of displaying the seat belt status visually with visual signals displayed by the monitor.

### FIELD OF THE INVENTION

The present device relates to systems for monitoring seat belt function in particular relates to a seat belt monitoring system and method of use including wireless monitors and sensors for monitoring the status of rear seat belts.

### SUMMARY OF THE INVENTION

Currently passenger vehicles such as automobiles, light trucks and buses are often outfitted with seat belts that are not monitored in any way by the driver to determine whether or not the seat belt is engaged or malfunctioning.

In passenger automobiles for example there are devices which sense the use of the engagement of front passenger seat belts however normally there is no indication for the driver as to the status or engagement of rear seat belts. Therefore the driver of the vehicle will not be made aware of for example if a rear passenger has disengaged one of the rear seat belts either intentionally or accidentally as may happen in the case of an infant and/or young child sitting in the rear seat.

Furthermore in commercial vehicles such as buses it is impossible for the bus driver to monitor the status of seat belts throughout the entire bus. There is no system for alerting the driver that children, which are riding on a bus, have or have not engaged the seat belt properly.

Therefore there is a need for a system and method of monitoring the status of seat belt engagement in the rear seats of passenger vehicles and light trucks as well as commercial vehicles such as buses to ensure the safety of the passengers aboard these vehicles and also to help the driver in determining whether or not the passengers on board his vehicle have properly engaged the seat belts and safety restraint devices that are available for use on board the vehicle.

### BRIEF DESCRIPTION OF THE DRAWINGS

The present device will now be described by way of example only with reference to the following drawings in which;

FIG. 1 is a side devotional view of a monitor.

FIG. 2 is a top elevational view of the monitor shown in FIG. 1.

FIG. 3 is a top, side schematic perspective view of the monitor shown in FIG. 2.

FIG. 4 is a top, side elevational view of the anchor and belt portions of the sensor.

FIG. 5 is a side elevational view of the anchor and belt portions of the sensor.

FIG. 6 is a bottom side elevational view of the anchor and belt portions of the sensor.

FIG. 7 is a bottom side perspective view of the anchor and belt portions of the sensor.

FIG. 8 is a top side schematic perspective view of the anchor and belt portions of the sensor.

FIG. 9 is a top schematic perspective view of the anchor and belt portions of the sensor deployed onto the seat belt and seat belt anchor shown in the disengaged position.

FIG. 10 is a top schematic perspective view of the anchor and belt portions of the sensor deployed on the seat belt and seat belt anchor shown in the engaged position.

FIG. 11 is a schematic perspective view of the monitor mounted onto the dash inside of a vehicle.

FIG. 12 is a schematic perspective view of the sensors mounted onto the seat belt and the seat belt anchor in the rear seat of a vehicle.

FIG. 13 is a side elevational view of a vehicle as shown with a monitor mounted onto a dash as well as the sensors mounted onto the seat belt and seat belt anchors of a rear seat of the automobile.

FIG. 14 is a flowchart of the method of use of the seat belt monitoring system.

FIG. 15 is an alternate of the method of use of the seat belt monitoring system.

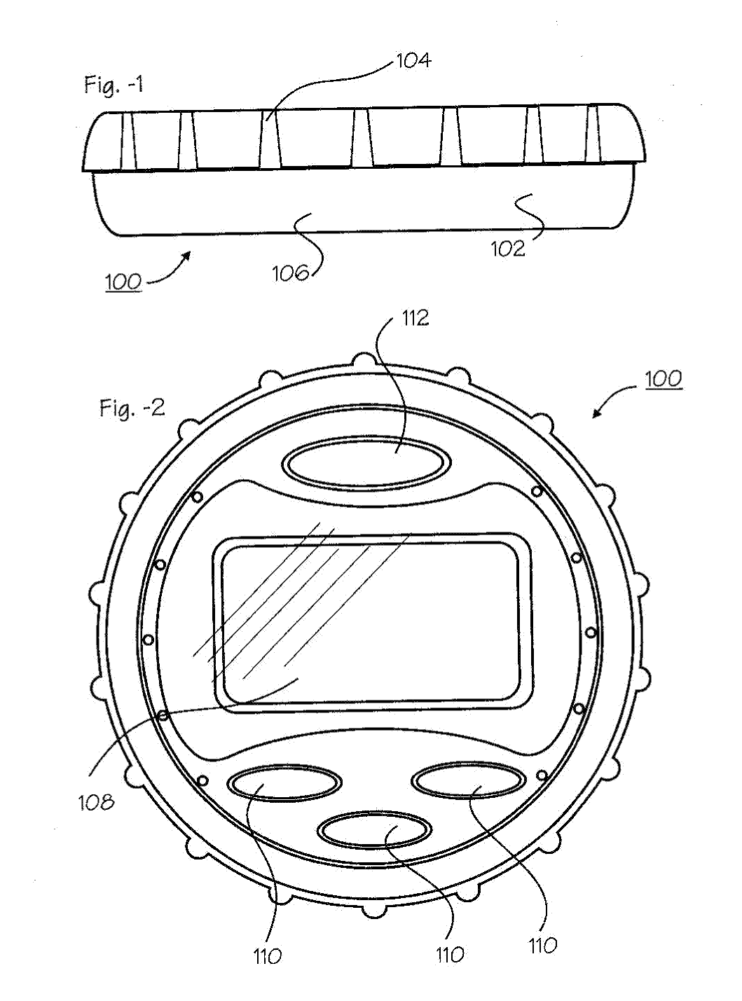

### DESCRIPTION OF THE PREFERRED EMBODIMENTS

The present device a seat belt monitoring system and method of use is comprised of the following major components namely a wireless monitor 100 which communicates wirelessly with sensors 200.

Monitor 100 includes a case 102 which is made up of a top portion 104 and a bottom portion 106.

Monitor 100 includes a display 108 in the top portion 104 of case 102 as well as lower buttons 110 and upper button 112.

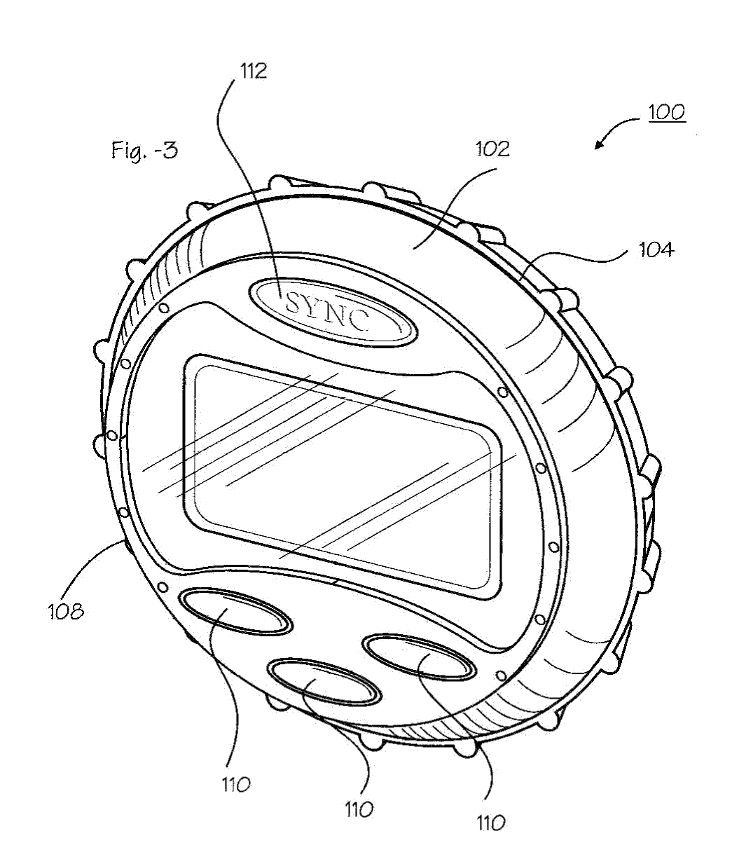

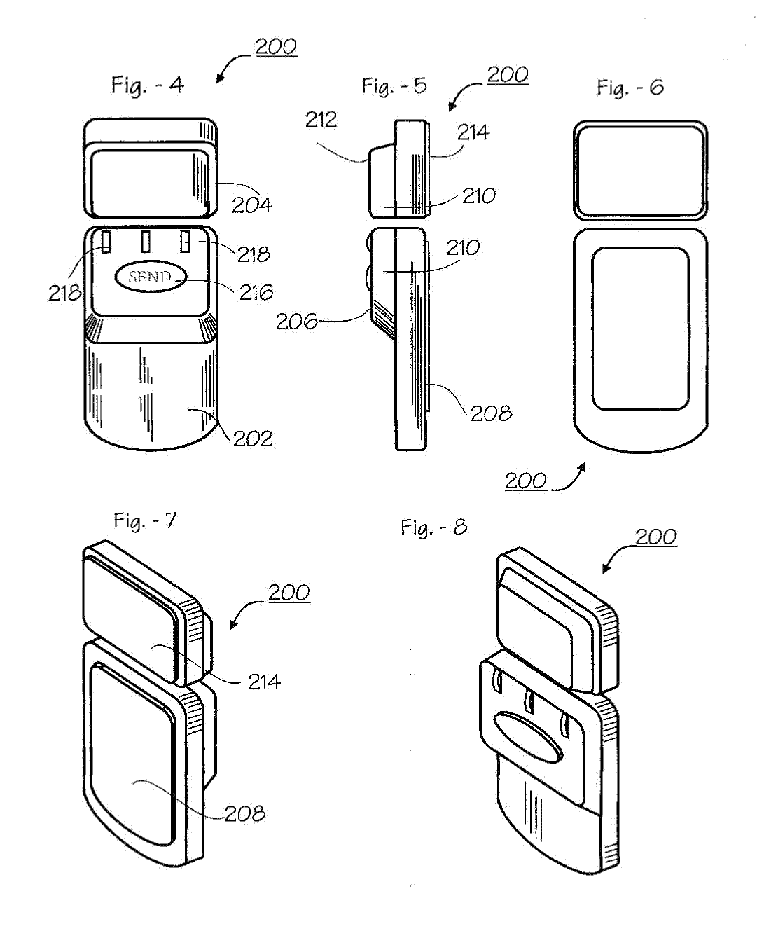

The number of buttons depicted in the diagram are schematic in nature and the actual monitor 100 may include a different number of lower buttons and upper buttons as that depicted in FIGS. 2 & 3.

The buttons 110 and 112 function to operate monitor 100 and depressing lower buttons 110 or upper button 112 will activate certain predetermined functions of monitor 100.

Monitor 100 communicates wirelessly with sensors 200.

Sensors 200 include a belt portion 202, which is affixed to the seat belt 230 and an anchor portion 204 which is affixed to the seat belt anchor 232.

Belt portion 202 includes a top side 206 and a bottom side 208 and as well a sensor 210. Anchor portion 204 includes a top side 212 and a bottom side 214 as well as a sensor 210

Sensor 210 is a proximity sensor of the type known in the art and can include an inductive type sensor, a capacitive type sensor, a radio frequency type proximity sensor, a wireless proximity sensor, and/or any other type of proximity sensor which will allow one to monitor the proximity between the belt portion 202 and the anchor portion 204.

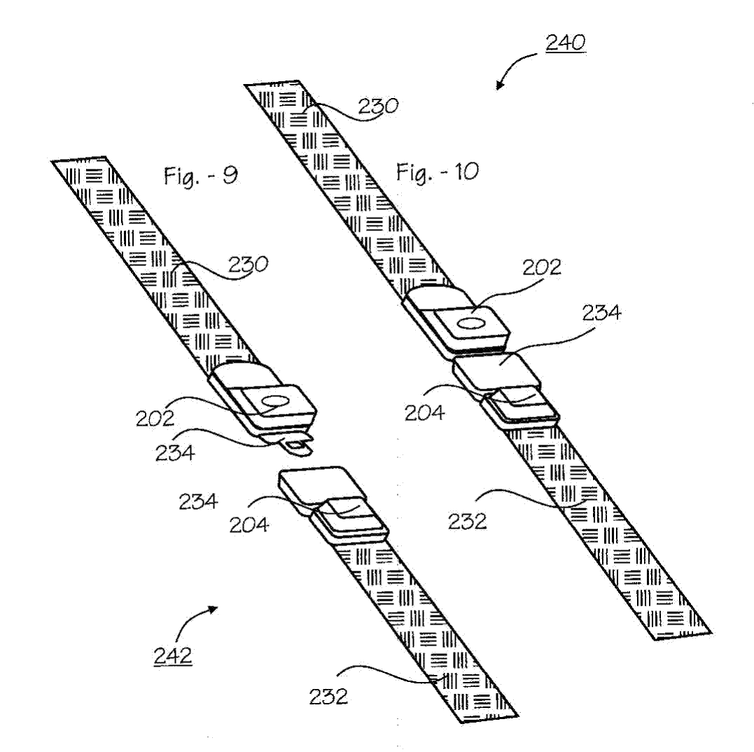

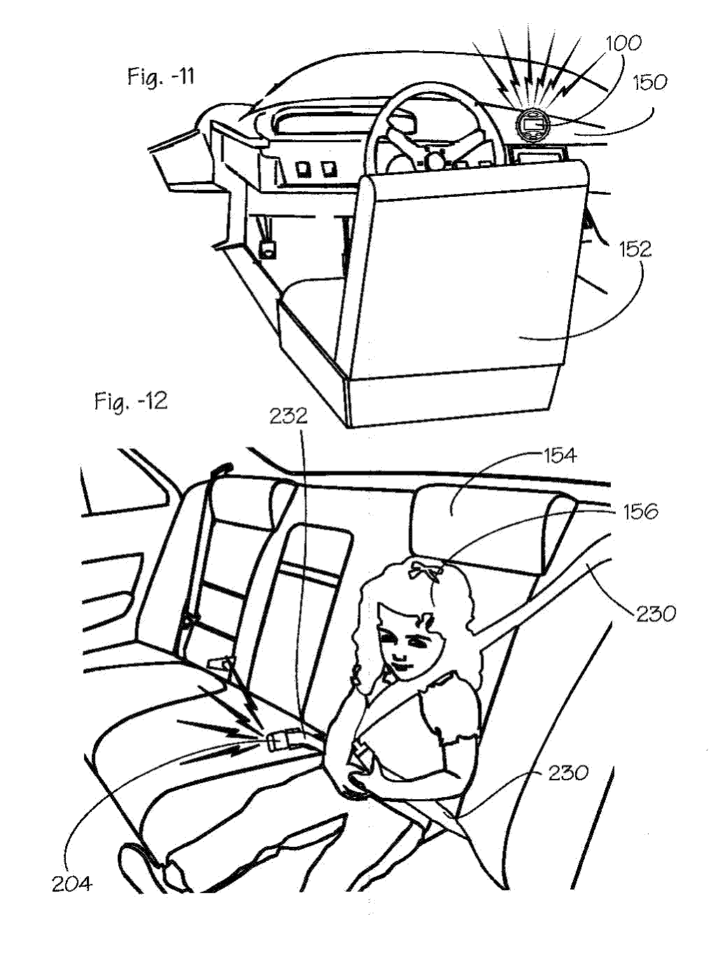

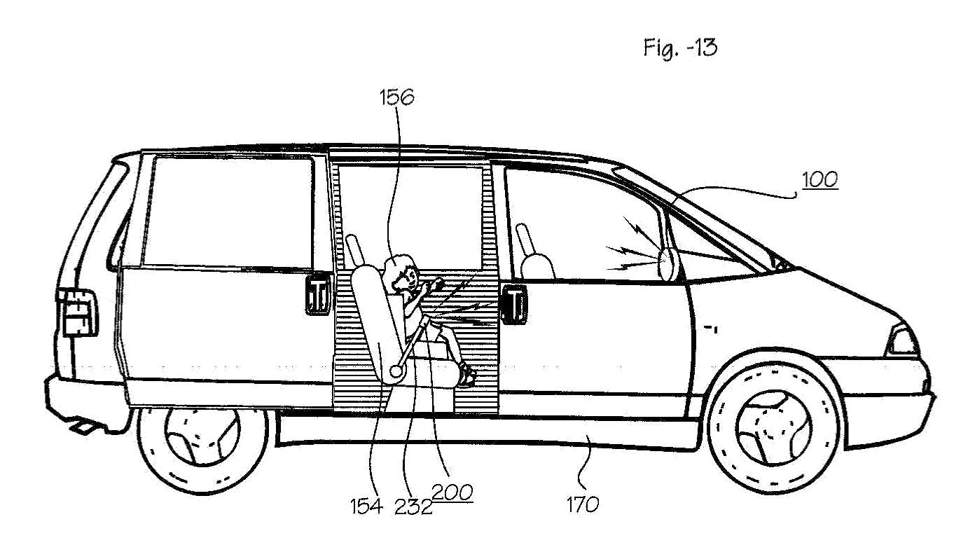

FIGS. 9 and 10 show sensors 200 deployed onto seat belt 230 and seat belt anchor 232.

In practice seat belt portion 202 is releasably affixed to seat belt 230 and anchor portion 204 is releasably affixed to seat belt anchor 232. Belt portion 202 and anchor portion 204 are likely spaced on either side of buckle 234 however it is possible that either anchor portion 204 and/or belt portion 202 may in fact overlap overtop of buckle 234 if it is necessary in order to obtain the optimum spacing between sensors 210 of the belt portion 202 and the anchor portion 204.

### In Use

As shown in FIG. 11 preferably monitor 100 is mounted onto the dash 150 of a vehicle.

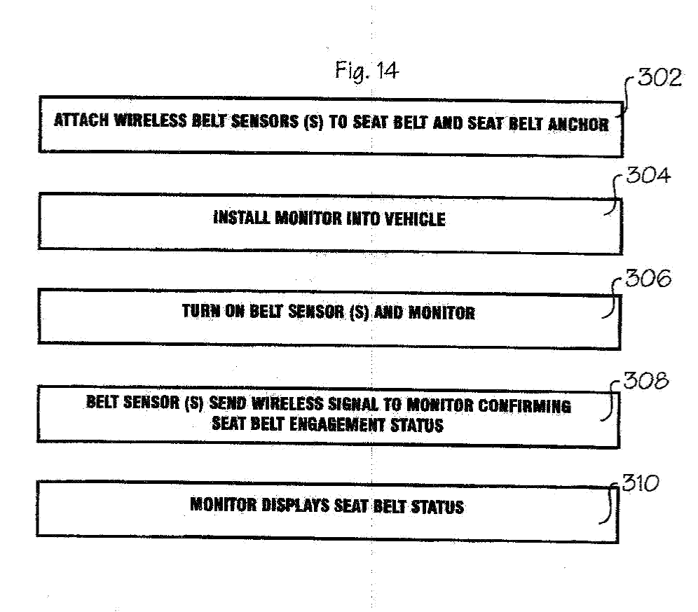

As shown in FIG. 12 belt portion 202 of sensor 200 is attached to seat belt 230 and anchor portion 204 of sensor 200 is attached to seat belt anchor 232 such that when the seat belt is in the engaged position 240 as shown in FIG. 10 the sensors determine that in fact the anchor portion 204 and the belt portion 202 are in close enough proximity that they would determine that the seat belt has been properly engaged.

In the disengaged position 242 as shown in FIG. 9 proximity sensors 210 of belt portion 202 and anchor portion 204 would determine that the space between sensors 210 has become so large that it is not possible that seat belt 230 and seat belt anchor 232 are any longer in the engaged position 240 and in fact seat belt and seat belt anchor 232 have become placed in the disengaged position 242 indicating that the seat belt is no longer engaged.

FIG. 11 shows monitor 100 mounted on a dash 150 in front of the front seat 152.

FIG. 12 shows anchor portion 204 mounted onto seat belt anchor 232 as well as seat belt 230. FIG. 12 also shows a passenger 156 sitting in the rear seat 154.

FIG. 13 a schematic inside elevational view an automobile 170 having the door open wherein passenger 156 is seated in a rear seat 154 with seat belt anchor 132 having sensor 200 mounted thereon in wireless communication with monitor 100 mounted onto the dash.

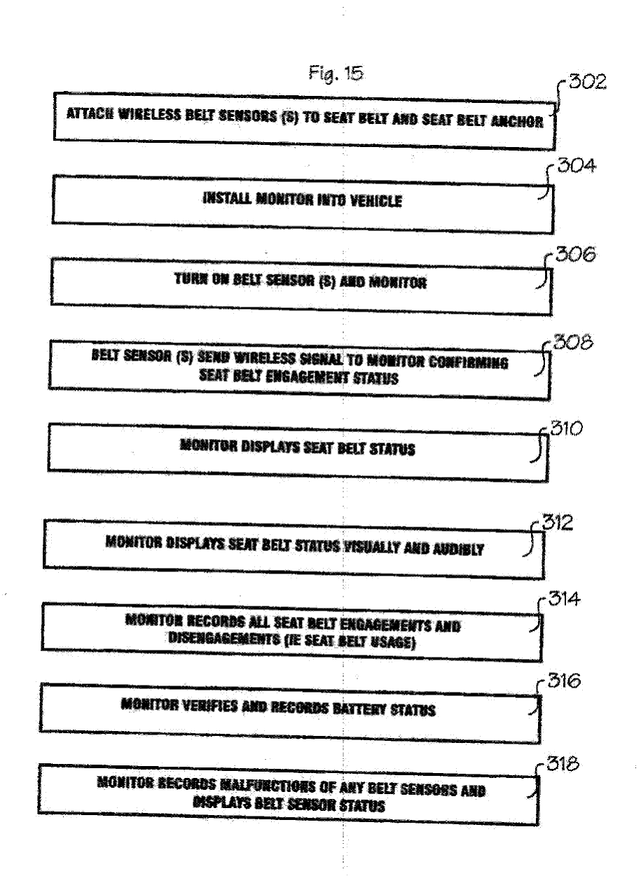

One of the methods of use of the seatbelt monitoring system is shown in a schematic flowchart fashion in FIG. 14 as follows;
1. Attaching wireless belt sensors to the seat belt and seat belt anchor shown as 302 in FIG. 14.
2. Installing the monitor into the vehicle preferably onto the dash shown as 304 in FIG. 14.
3. Turning on the belt sensors and the monitor shown as 306 in FIG. 14.
4. The belt sensors sending wireless signals to the monitor confirming the seatbelt engagement status shown as 308 in FIG. 14.
5. The monitoring displaying the seat belt status to the driver of the vehicle shown as 310 in FIG. 14.

An alternate method of use of the seat belt monitoring system is depicted in flowchart fashion in FIG. 15 as follows:
1. Attaching the wireless belt sensors to the seat belt and seat belts anchors shown as 302 in FIG. 15.
2. Installing the monitor preferably onto the dash into the vehicle shown as 304 in FIG. 15.
3. Turning on the seat belt sensors and also the monitor shown as 306 in FIG. 15.
4. The belt sensors then sending wireless signals to the monitor confirming seat belt engagement status shown as 308 in FIG. 15.
5. The monitoring displaying the seat belt status visually through lights and audibly through sounds shown as 312 in FIG. 15.
6. The monitor in recording all seat belt engagements and disengagements over time and creating a log of seatbelt engagements and disengagements shown as 314 in FIG. 15.
7. The monitoring continuously verifying and recording the battery status and whether or not the batteries are low and are requiring replacement and recording over time the status of the batteries shown as 316 in FIG. 15.
8. The monitor recording malfunctions of any of the seat belt sensors and displaying whether or not any of the seatbelt sensors are defective or not working in recording any malfunctions over time shown as 318 in FIG. 15.

A method of monitoring status of rear seat belts includes the following steps:
a) attaching wireless belt sensors including a belt portion to a seat belt and an anchor portion to a seat belt anchor;
b) installing a monitor into the vehicle;
c) turning on the belt sensors and the monitor;
d) sending wireless signals from the sensors to the monitor confirming the seatbelt engagement status;
e) displaying the seat belt status to the driver of the vehicle with a monitor display.

The method further including the step of displaying the seat belt status visually with visual signals displayed by the monitor.

The method further including the step of displaying the seat belt status audibly through sounds emitted by the monitor.

The method further including the step of recording all seat belt engagements and disengagements over time and creating a log of seatbelt engagements and disengagements in a memory of the monitor.

The method further including the step of continuously verifying and recording the battery status and whether or not the batteries are low and are requiring replacement and recording the status of the batteries in the memory of the monitor.

The method further including the step of recording malfunctions of any of the seat belt sensors and displaying on the monitor whether or not any of the seatbelt sensors are defective or not working and recording any malfunctions in the memory of the monitor.

It should be apparent to persons skilled in the art of various modification and adaptations of the structure described above are possible without departure from the spirit of the invention the scope of which is defined in the appended claims.

I claim:

1) A method of monitoring status of rear seat belts comprising the following steps:
a) attaching wireless belt sensors including a belt portion to a seat belt and an anchor portion to a seat belt anchor;
b) installing a monitor into the vehicle;
c) turning on the belt sensors and the monitor;
d) sending wireless signals from the sensors to the monitor confirming the seatbelt engagement status;
e) displaying the seat belt status to the driver of the vehicle with a monitor display.

1) The method claimed in claim 1 further including the step of displaying the seat belt status visually with visual signals displayed by the monitor.

2) The method claimed in claim 1 further including the step of displaying the seat belt status audibly through sounds emitted by the monitor.

3) The method claimed in claim 1 further including the step of recording all seat belt engagements and disengagements over time and creating a log of seatbelt engagements and disengagements in a memory of the monitor.

4) The method claimed in claim 1 further including the step of continuously verifying and recording the battery status and whether or not the batteries are low and are requiring replacement and recording the status of the batteries in the memory of the monitor.

5) The method claimed in claim 1 further including the step of recording malfunctions of any of the seat belt sensors and displaying on the monitor whether or not any of the seatbelt sensors are defective or not working and recording any malfunctions in the memory of the monitor.
